(19) United States
(12) Patent Application Publication
(10) Pub. No.: US 2002/0110011 A1
(43) Pub. Date: Aug. 15, 2002

(54) POWER CONVERTER WITH OUTPUT LEVEL CONTROL CIRCUITRY

(76) Inventor: Carl C. D'Esposito, Lindenhurst, NY (US)

Correspondence Address: VARNUM, RIDDERING, SCHMIDT & HOWLETT LLP, P.O. BOX 352, GRAND RAPIDS, MI, 49501, US

(21) Appl. No.: 09/783,668

(22) Filed: Feb. 14, 2001

(51) Int. Cl. H02M 7/00

(52) U.S. Cl. 363/125

(57) ABSTRACT

A three-phase AC-DC power converter includes input signal control circuitry responsive to changes in power converter output signal levels to selectively increase and decrease magnitude of input signals in order to provide a more nearly constant output signal level.

### BACKGROUND OF THE INVENTION

1. Field of the Invention

The invention relates to single and multi-phase rectification circuits and, more particularly, to circuitry for regulating output level of AC to DC power converters.

2. Background Art

For certain applications, such as power converter units for aircraft which provide power to a plurality of DC motors and other apparatus, a power supply must be able to consistently provide adequate output power under various, rapidly changing conditions occurring in flight. A problem with prior art regulated power converters is that the output is not well regulated when demands exceeds nominal variations. A particular problem with prior art regulated power converters is that they fail to provide output power at a consistently high level at times of highest demand. Such a condition may result in delayed activation or an impaired operation of certain critical systems and jeopardize the flight of the aircraft. Certain prior art regulated AC-to-DC power converters employ thyristor control circuitry, in association with a multi-phase transformer and various rectification schemes, in order to produce regulated DC output power. However, the overload capability of such prior art power converters is extremely limited, as compared to an unregulated power converters, and fail to supply adequate output power at critical times when the demand for power is highest. Other prior art regulated AC-to-DC converters utilize high frequency power conversion techniques in order to provide regulated output power. While these techniques are varied and well known, they also fail to provide adequate output power at critical times, when demand for power is highest. A further disadvantage of these prior art devices is that both thyristors and high frequency power converters yield low power factors, since both require high harmonic input currents.

### SUMMARY OF THE INVENTION

These and other problems of the prior art are overcome in accordance with the present invention by controlling the input signal of a regulated power converter in response to changes in the output DC signal level. In one embodiment of the invention, such control is accomplished by monitoring the output signal of a transformer-rectifier circuit and adjusting the input signal to effect a change in the DC output level. In this manner, the output level is maintained at a regulated output level.

Advantageously, power converters in accordance with the invention have power overload capabilities similar to an unregulated AC to DC converter, while providing a high power which is on the order of 0.97.

In one embodiment of the invention, a level detection circuit connected to outputs of the power converter provides a control signal indicative of the level of the output signal and an input signal modification circuit is responsive to the control signal to adjust the level of the input signal. In this manner, the output signal is regulated at a consistently high level.

In a specific embodiment of the invention, a “boost” signal is provided, increasing the level of the input signal, when the output signal attempts to fall below the predetermined regulated output level. Similarly, a “buck” signal is provided, decreasing the level of the input signal, when the output signal attempts to exceed a predetermined regulated output level. In this manner the amplitude of the input signal, and hence, the level of the output signal, is increased at times of high demand and is decreased at times of low demand. This is accomplished in a linear fashion throughout the complete regulation range.

In one particular embodiment of the invention, the buck/boost signal is in the form of a square wave. The phase of square wave is selectively shifted relative to the phase of the input sine wave to adjust the level of the input signal as necessary to maintain a substantially constant DC output level. In this manner the level of the input signal and, hence, the level of the output DC signal, is selectively increased and decreased in accordance with variations in demand and variations in the input sine wave.

### BRIEF DESCRIPTION OF THE DRAWINGS

FIG. 1 is a diagrammatic representation of a DC power supply circuit incorporating the principles of the invention; and

FIGS. 2 through 4 are representations of transformer input signals under various load conditions.

### DETAILED DESCRIPTION

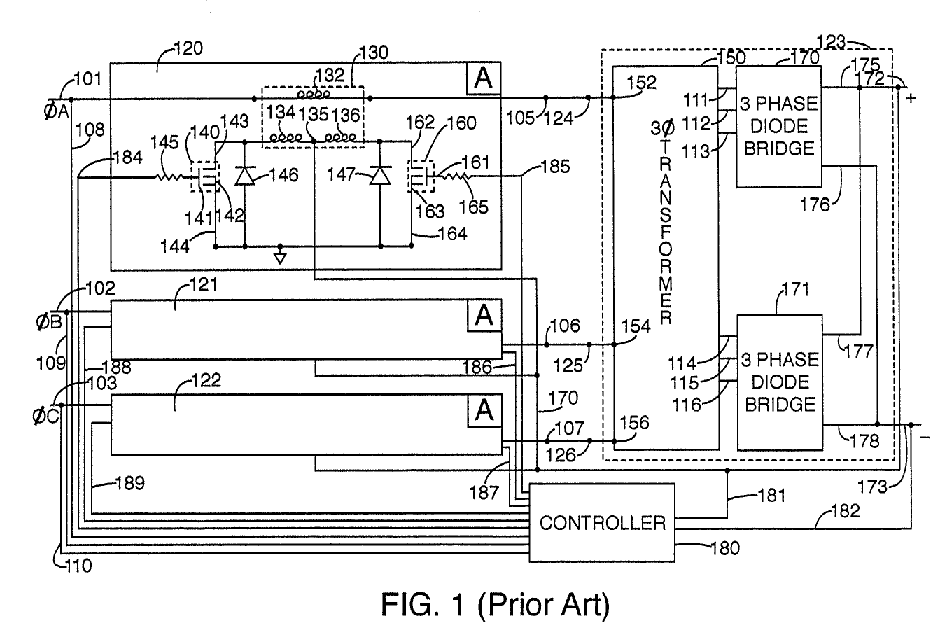

The circuit of FIG. 1 includes a controller 180 and three input signal control circuits 120 through 122. Input terminals 101 through 103 of the control circuits 120 through 122 are connected to phase outputs A, B and C, respectively, of a three-phase alternating current source (not shown in the drawing). Output terminals 105 through 107 of the control circuits 120 through 122 are connected to input terminals 124 through 126, respectively, of a prior art AC-to-DC converter circuit 123. The AC-to-DC may be any of a plurality of prior art converters and may include delta-wye, forked wye or other multi-phase secondaries. Output terminals 105, 106 and 107, are connected to input terminals 124, 125 and 126, respectively, of converter circuit 123. Circuit 123 includes a well-known three-phase transformer 150, and may include delta-wye, forked wye or other multiphase secondary windings. The transformer 150 has three input terminals 152, 154 and 156, connected to converter input terminals 124 through 126, respectively, and six output conductors, 111 through 116. Output terminals 111 through 113 are connected to a prior art, three-phase diode-bridge 170 and output terminals 114 through 116 are connected to a similar prior art bridge 171. Bridge 170 has an output terminal 175 connected to converter circuit output terminal 172 and an output terminal 176, connected to converter circuit output terminal 173. Similarly, bridge 171 has an output terminal 177 connected to terminal converter circuit output terminal 172 and an output terminal 178 connected to converter circuit output terminal 173.

The circuitry for input signal control circuit 120 is shown in FIG. 1 in detail, while input signal control circuits 121 and 122 are shown in block form only. It will be understood that the circuit elements and operation of the circuits of the blocks labeled 121 and 122 are identical to that shown for block 120 in FIG. 1 and will function in the same manner as the circuit of control circuit 120, which is described in detail below.

Control circuit 120 includes a transformer circuit 130 having a coil 132 connected between input conductor 101 and output conductor 105 and is disposed in close proximity to a pair of adjacently disposed coils 134, 136. Coils 134 and 136 are inductively coupled to coil 132 and each of the coils 134, 136 has one end connected to node 135. The coil 134 has an opposite end, opposite node 135, connected to the drain 143 of a field effect transistor 140, and the coil 136 has an opposite end, opposite the node 135, connected to the drain 162 of a field effect transistor 160. The source 142 of transistor 140 and the source 163 of transistor 160 are connected to a common ground via conductor 144. Further connected between the drain 143, and ground and between drain 162 and ground, are diodes 146 and 147, respectively. The gate 141 of transistor 140 is connected to a control conductor 184 via a resistor 145 and the gate 161 of the transistor 160 is connected to a control conductor 185 via a resistor 165. Conductors 184 and 185 are output conductors of controller 180 and signals on conductors 184 and 185 serve to selectively switch the transistor 140, 160 between a fully conductive state and a non-conductive state under control of controller 180. Current flow through coils 134 and 136 induces a voltage across coil 132. This induced voltage modifies the input signal received on conductor 101 and serves to selectively increase and decrease the magnitude of the input sine wave applied to terminal 124 of converter 123 and, hence, the level of the of the output signal of converter 123.

Current flow through coils 134, 136 is controlled by the selective operation of transistors 140, 160 under control of controller 180. Current flows through coil 134 from the node 135 to ground via transistor 140, when transistor 140 is turned on, inducing a voltage in coil 132 in a first direction. Similarly, current flows through coil 136 from the node 135 in one direction when transistor 160 is turned on, inducing a voltage in coil 132 in direction opposite the first direction. When neither of the transistors 140, 160 is turned on, equal currents alternately flow in the coils 134, 136 in opposite directions, via diodes 146, 147.

Control signals generated by a controller 180 on conductors 184 through 189 control the transistors 140, 160 and corresponding transistors in circuits 121, 122 to selectively increase and decrease the magnitude of signals applied to input terminals 124 through 126 of the transformer 150. The amplitude of the signals induced in coil 132 is primarily a function of the relative values of the coils 132, 134 and 136. In one embodiment of the invention, the coil 132 has an inductance value of 20 mh and the coils 134 and 136 each have an inductance value of 120 mh.

The controller 180 may be constructed of one or more well-known and commercially available pulse-width current or voltage controllers. In one embodiment of the invention, controller 180 includes three current controllers. Controller 180 has input conductors 181, 182 connected to output terminals 172, 173, respectively, of the AC-to-DC converter 123 and input conductors 108, 109 and 110 connected to the three phase input terminals 101, 102 and 103, respectively. Signals from the phase input terminals 101, 102 and 103 provide phase synchronization for the current controllers of controller 180. Controller 180 controls the operation of the transistors 140, 160 by control signals on conductors 184 and 185, respectively, and controls corresponding transistors of the circuits 121 and 122 by control signals on conductor pairs 186, 188 and 187, 189, respectively.

The controller 180 is connected to the output terminals 172 and 173 of the AC-to-DC converter circuit 123 via conductors 181 and 182, respectively. Controller 180 is responsive to changes in output levels on terminals 172 and 173 to generate appropriate control signals on control conductors 184 through 189, thereby controlling the selective activation and deactivation of the transistors 140, 160 in circuit 120 and corresponding transistors in circuits 121 and 122. Furthermore, control circuit 180 monitors input signals on conductors 101, 102 and 103 via conductors 108, 109 and 110, respectively, for proper timing of the generated control signals for the transistors 140, 160 of circuit 120 and corresponding control signals for the circuits 121 and 122.

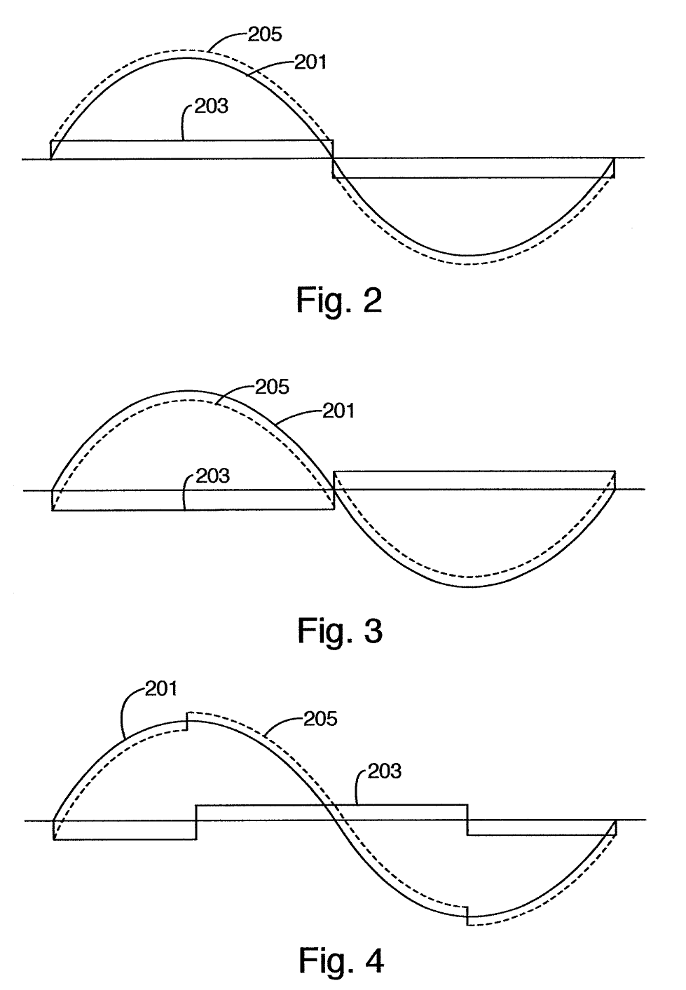

FIG. 2 graphically depicts a modified signal 205 occurring on terminal 124, in what is referred to herein as a “full-boost” condition. In this condition, the input signal 201 is enhanced by the addition of a square wave signal 203, induced in coil 132, in phase with the input sine wave signal 201. Consequently, the magnitude of the square wave signal 203 is added to the magnitude of the input sine wave signal 201. The resulting enhanced signal 205 is applied to terminal 124 of the converter circuit 123, thereby providing an enhanced output signal on output terminals 172, 173. It will be apparent to those skilled in the art that the magnitude of the input signal applied to terminal 124, and to input terminal 152 of the three-phase transformer 150, may be increased by a substantial value. Furthermore, the value of the increase may be readily adjusted for various applications by proper selection of the coils 132, 134, and 136.

Shown in FIG. 3 are the signals 201, 203 and 205 in what is referred to as the “full buck” condition. In this condition, the square wave signal 201 induced in coil 132 is phase shifted by 180 degrees from the position shown in FIG. 2. The resulting signal is diminished from the level of the signal on terminal 101 by a predetermined value, as graphically depicted in FIG. 3. Consequently, the level of the signals on terminal 172, 173 is decreased. Based on the above description, it is apparent that the level of output signals on conductors 172, 173 may be increased in the full boost mode when the output level begins to drop, under a heavy load, and may be decreased in the full buck mode when the output level begins to rise, in the case of a reduced load on the circuit.

FIG. 4 depicts the signals 201, 203 and 205 in what is referred to as a neutral “buck/boost” mode, for example, when the input line is nominal and the load is approximately 50 percent of full load. In that mode, the transistors 140, 160 are controlled by controller 180 so as to cause the signals induced in the coil 132 to be approximately 90 degrees out of phase with the incoming signal. In this manner, the output voltage of the AC-to-DC converter 123 can be maintained at a required regulated level. It will be apparent that, by control of the transistors 140, 160, the level of the input signal may be increased in a full boost mode to meet maximum demand and may be controlled to reduce the input signal in the full buck mode when the demand for output power is low. Further, the input signal may be adjusted to any desired intermediate level under control of the pulse width modulated current controller 180.

It will be apparent to those skilled in the art that various modifications may be made to the circuit of the invention without departing from the spirit and scope of the invention as defined by the appended claims.

1. A control circuit for controlling output levels of a transformer-rectifier unit having a transformer-rectifier input terminal and a transformer-rectifier output terminal, said control circuit comprising:
a first control circuit input terminal for connection to an alternating signal generating power source generating alternating current input signals of a predetermined amplitude;
a second control circuit input terminal for connection to said transformer-rectifier output terminal;
a control circuit output terminal for connection to said transformer-rectifier input terminal; and
signal level control circuitry connected to said first and second control circuit input terminals and to said transformer-rectifier output terminal, said signal level control circuitry responsive to changes in signal levels at said transformer-rectifier output terminal to generate modified transformer-rectifier input signals on said control circuit output terminal, said modified transformer-rectifier input signals having an amplitude differing from said predetermined amplitude.

2. The control circuit in accordance with claim 1, wherein said signal level control circuitry comprises a transformer circuit including a first coil connected between said first control circuit input terminal and said control circuit output terminal and second and third coils disposed adjacent said first coil, said control circuit further comprising circuitry for controlling current flow in said second and said third coils to generate said modified transformer-rectifier input signals by selectively increasing and decreasing amplitudes of said alternating current input signals.

3. The circuit in accordance with claim 2 wherein said circuitry for controlling current flow in said second and third coils comprises a first transistor for controlling current flow in said second coil and a second transistor for controlling current flow in said third coil.

4. The control circuit in accordance with claim 3 wherein said circuitry for controlling current flow in said second and third coils further comprises a signal controller having a first input terminal connected to said first control circuit input terminal and a second input terminal connected to said second control circuit input terminal, and
first and second output terminals connected to said first and said second transistors, respectively, said signal controller responsive to changes in signal levels on said transformer-rectifier output terminal to control said first and said second transistors to selectively increase and decrease current flow in said second and third coils, whereby said amplitude of said input signal is selectively in creased and decreased in response to changes in said signal level of said transformer output terminal.

5. A power converter for converting an AC input signal to a regulated DC output signal, said converter comprising:
a transformer-rectifier circuit having an input terminal and an output terminal; and
a control circuit comprising a first input terminal for connection to a source of alternating current and a second input terminal connected to said output terminal of said transformer-rectifier circuit and a control circuit output terminal connected to said input terminal of said transformer-rectifier circuit;
said control circuit responsive to a change in signal level of a signal on said second input terminal and an AC input signal received on said first input terminal to generate a modified amplitude AC input signal on said control circuit output terminal, whereby a change in output signal level on said transformer-rectifier output terminal results in the application of modified input signal on said transformer-rectifier input terminal.

6. The power converter in accordance with claim 5 wherein said amplitude of said modified amplitude AC input signal is increased when said change in signal level is in a negative direction from a predetermined level and is decreased when said change in signal level is in a positive direction from said predetermined level.

7. The power converter in accordance with claim 5 wherein said control circuit comprises a transformer circuit including a first coil connected between said first control circuit input terminal and said control circuit output terminal and second and third coils disposed adjacent said first coil, said control circuit further comprising circuitry for controlling current flow in said second and said third coils to generate said modified amplitude AC signal.

8. The power converter in accordance with claim 7 wherein said circuitry for controlling current flow in said second and third coils comprises a first transistor for controlling current flow in said second coil and a second transistor for controlling current flow in said third coil.

9. The control circuit in accordance with claim 8 wherein said circuitry for controlling current flow in said second and third coils further comprises a signal controller having a first input terminal connected to said first control circuit input terminal and first and second output terminals connected to said first and said second transistors, respectively, said signal controller responsive to changes in signal levels on said transformer-rectifier output terminal to control said first and said second transistors to selectively increase and decrease current flow in said second and third coils, whereby said amplitude of said input signal is selectively in creased and decreased in response to changes in said signal level of said transformer output terminal.

10. A power converter for converting three-phase AC input signals of a predetermined amplitude to a regulated three-phase DC output signal, said converter comprising a transformer-rectifier unit having first, second and third transformer-rectifier input terminals and a transformer-rectifier output terminal, said power converter further comprising control circuitry for controlling output signal levels on said transformer-rectifier output terminal, said control circuitry comprising:
first, second and third control circuit input terminals for connection to first, second and third alternating current sources, respectively;
a fourth control circuit input terminal connected to said rectifier output terminal;
first, second, and third control circuit output terminals connected to said first, second and third transformer-rectifier input terminals, respectively;
said control circuitry responsive to changes in signal level of signals on said fourth control circuit input terminal and AC signals on said first, second and third control circuit input terminals to generate modified amplitude AC input signals on said first, second and third transformer input terminals, whereby a change in output signal amplitude on said transformer-rectifier output terminal results in application of modified amplitude input signals on said transformer-rectifier input terminals.

11. The power converter in accordance with claim 10 wherein said modified amplitude AC input signals each have an amplitude greater than a prior amplitude when said change in signal level is in a negative direction from a predetermined level and each have an amplitude smaller than said prior amplitude when said change in signal level is in a positive direction from said predetermined level

12. The power converter in accordance with claim 10 wherein said control circuitry comprises transformer circuitry connected to said first, second and third input terminals and to said first, second and third output terminals and control circuitry for controlling current flow in said in said transformer circuitry.

13. The power converter in accordance with claim 12 wherein said transformer circuitry comprises first, second and third transformers, each of said transformers comprising a first coil connected between one of said control circuit input terminals and one of said control circuit output terminals and second and third coils disposed adjacent each of said first coils, said control circuit further comprising circuitry for controlling current flow in said second and said third coils.

14. The power converter in accordance with claim 13 wherein said circuitry for controlling current flow in said second and third coils comprises a plurality of transistors for selectively controlling current flow in said second and third coils.

15. The power converter in accordance with claim 14 wherein said circuitry for controlling current flow in said second and third coils further comprises a signal controller comprising input terminals connected to said first, said second and said third and said fourth control circuit input terminals and to said plurality of second and third coils and comprising output terminals connected to said plurality of said first and said second transistors, said signal controller responsive to changes in signal levels on said transformer-rectifier output terminal to control said plurality of said first and said second transistors to selectively increase and decrease current flow in said plurality of second and third coils, whereby said input signals on said transformer-rectifier input terminals are selectively in creased and decreased in response to changes in signal level on said transformer-rectifier output terminal.
